(19) United States
(12) Patent Application Publication
(10) Pub. No.: US 2007/0018020 A1
(43) Pub. Date: Jan. 25, 2007

(54) CABINET WITH PAPER SHREDDING FUNCTION

(76) Inventor: Chun-Fong Wang, Hou Hu Li (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/160,991

(22) Filed: Jul. 19, 2005

(51) Int. Cl. B02C 18/16

(52) U.S. Cl. 241/100

(57) ABSTRACT

A cabinet with paper shredding function comprises an installation space for installation of a paper shredder, wherein two opposite support ribs are disposed at both sides of the installation space of a housing of the cabinet, each of the support ribs is formed at either end thereof with a mounting hole, a base board has a plurality of inserting holes that are in alignment with the mounting holes of the two support ribs, such that the base board is mounted on the two support ribs by fixing fasteners in the mounting holes and the supporting ribs, the base board is further formed with a mounting slot for positioning the paper shredder, and after being mounted on the base board, the paper shredder is covered with a cover, and the cover has a slot that is identical to a paper feeding hole of the paper shredder in size.

### BACKGROUND OF THE INVENTION

1. Field of the Invention

The present invention relates to a cabinet with paper shredding function, and more particularly to a cabinet in which a plurality of drawers are organized, and in a predetermined position in a housing of the cabinet is further arranged a paper shredder.

2. Description of the Prior Art

Office equipment is indispensable to people's daily life and includes miscellaneous types, such as printer, computer, desk, cabinet, paper shredder, and so on. These equipments are generally separately arranged, so that they not only look untidy but also occupy a large space. Therefore, many efforts have been and are being to make the office equipment more compact, integrated and versatile, and this is also the motivation of the invention to provide a cabinet with a paper shredder.

### SUMMARY OF THE INVENTION

The primary objective of the present invention is to provide a spacing saving cabinet with paper shredding function, that is, a combination of a cabinet and a paper shredder.

A cabinet with paper shredding function in accordance with the present invention comprises an installation space for installation of a paper shredder, wherein two opposite support ribs are disposed at both sides of the installation space of a housing of the cabinet, each of the support ribs is formed at either end thereof with a mounting hole, a base board has a plurality of inserting holes that are in alignment with the mounting holes of the two support ribs, such that the base board is mounted on the two support ribs by fixing fasteners in the mounting holes and the supporting ribs, the base board is further formed with a mounting slot for positioning the paper shredder, and after being mounted on the base board, the paper shredder is covered with a cover, and the cover has a slot that is identical to a paper feeding hole of the paper shredder in size.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is an exploded view of a part of a cabinet with paper shredding function in accordance with the present invention;

FIG. 2 is a perspective view of the cabinet with paper shredding function in accordance with the present invention;

FIG. 3 is a cross sectional view of the cabinet with paper shredding function in accordance with the present invention;

FIG. 4 is another cross sectional view of the cabinet with paper shredding function in accordance with the present invention.

### DETAILED DESCRIPTION OF THE PREFERRED EMBODIMENT

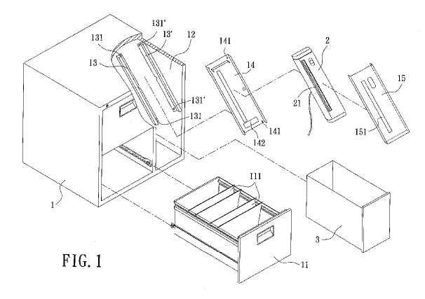

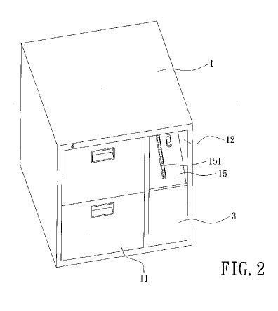

Referring to FIGS. 1 and 2, a cabinet with paper shredding function in accordance with the present invention comprises a housing 1 in which are received a plurality of drawers 11, and in each of drawers 11 are inserted a plurality of hanging files 111. In a predetermined portion of the housing 1 is an installation space 12 for installation of a paper shredder 2, and under the paper shredder 2 is arranged a shredded paper collector 3.

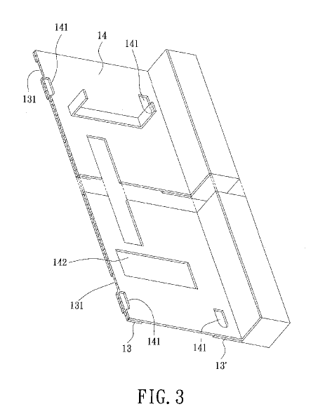

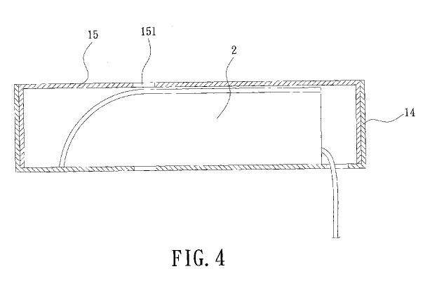

Referring to FIGS. 3 and 4, two opposite support ribs 13 and 13′ are disposed at both sides of the installation space 12 of the housing 1, each of the support ribs 13 and 13′ is formed at either end thereof with a mounting hole 131, 131′. A base board 14 has four inserting holes 141 that are in alignment with the mounting holes 131, 131′ of the two support ribs 13, 13′, such that the base board 14 can be mounted on the two support ribs 13, 13′ by fixing fasteners in the mounting holes and the supporting ribs. The base board 14 is further formed with a mounting slot 142 for positioning the paper shredder 2, and after being mounted on the base board 14, the paper shredder 2 is covered with a cover 15, and the cover 15 has a slot 151 that is in alignment with and identical to the paper feeding hole 21 of the paper shredder 2 in size.

While we have shown and described various embodiments in accordance with the present invention, it should be clear to those skilled in the art that further embodiments may be made without departing from the scope of the present invention.

What is claimed is:

1. A cabinet with paper shredding function comprising a paper shredder mounted in a predetermined position in a housing thereof.

2. The cabinet with paper shredding function as claimed in claim 1, wherein a shredded paper collector is arranged under the shredder.

3. A cabinet with paper shredding function comprising an installation space for installation of a paper shredder, wherein two opposite support ribs are disposed at both sides of the installation space of a housing of the cabinet, each of the support ribs is formed at either end thereof with a mounting hole, a base board has a plurality of inserting holes that are in alignment with the mounting holes of the two support ribs, such that the base board is mounted on the two support ribs by fixing fasteners in the mounting holes and the supporting ribs, the base board is further formed with a mounting slot for positioning the paper shredder, and after being mounted on the base board, the paper shredder is covered with a cover, and the cover has a slot that is identical to a paper feeding hole of the paper shredder in size.
